(19) United States
(12) Patent Application Publication
(10) Pub. No.: US 2010/0066719 A1
(43) Pub. Date: Mar. 18, 2010

(54) LIQUID CRYSTAL DISPLAY DEVICE, ITS DRIVING CIRCUIT AND DRIVING METHOD

(76) Inventor: Kazuma Hirao, Osaka (JP)

Correspondence Address: HARNESS, DICKEY & PIERCE, P.L.C., P.O. BOX 8910, RESTON, VA, 20195, US

(21) Appl. No.: 12/449,521

(22) PCT Filed: Dec. 10, 2007
(86) PCT No.: PCT/JP2007/073757

§ 371 Date: Aug. 12, 2009

(30) Foreign Application Priority Data
Mar. 9, 2007 (JP) 2007-059374

(51) Int. Cl. G06F 3/038; G09G 3/36

(52) U.S. Cl. 345/213; 345/98

(57) ABSTRACT

The present invention relates to liquid crystal display devices employing the interlaced mode.

A normally black mode is employed as a light control method. A source driver subjects analog voltage signals (da, db) to polarity inversion every two horizontal scanning periods, the analog voltage signals being applied to source bus lines as driving video signals (Sa, Sb). A gate driver sequentially drives gate bus lines each being selected for one horizontal scanning. In an output portion (black signal insertion circuit) of the source driver, a blacking voltage is written by short-circuiting adjacent source bus lines after a lapse of one horizontal scanning period since the polarity inversion of the analog voltage signals (da, db) until the next polarity inversion of the analog voltage signals (da, db).

### TECHNICAL FIELD

The present invention relates to a liquid crystal display device, and particularly to an active-matrix liquid crystal display device for providing a screen display in the interlaced mode.

### BACKGROUND ART

Conventionally, “interlaced mode” and “progressive mode (non-interlaced mode)” are known as modes for scanning display device scanning lines. The interlaced mode refers to a mode for displaying a screen by plural rounds of vertical scanning, e.g., odd-numbered-row scanning lines being scanned by the first vertical scanning, and even-numbered-row scanning lines being scanned by the second vertical scanning. On the other hand, the progressive mode refers to a mode for displaying a screen by a single round of vertical scanning. In general, the interlaced mode is employed by televisions and the like, which mainly display moving images, while the progressive mode is employed by displays for personal computers and the like, which mainly display still images.

Incidentally, in liquid crystal display devices, the progressive mode has conventionally often been employed. However, in recent years the demand for reduction in power consumption has been increasing as to mobile terminals, such as cell phones and PDAs (Personal Digital Assistants). Accordingly, in liquid crystal display devices for mobile terminals, externally provided input data is received as progressive mode data, and displayed in the interlaced mode. According to such display devices, since the quantity of data transmission and the number of times of writing to liquid crystal are reduced, power consumption is reduced.

FIG. 4 provides signal waveform diagrams for a conventional liquid crystal display device employing the interlaced mode. FIGS. 4A to 4D illustrate waveforms of scanning signals G(1) to G(n) applied to gate bus lines in the first through fourth rows. FIGS. 4E and 4F illustrate waveforms of driving video signal Sa applied to odd-numbered-column source bus lines and driving video signal Sb applied to even-numbered-column source bus lines. Hereinafter, a period required for displaying an image to be displayed on a display portion will be referred to as “one frame period”, and the first and second vertical scanning periods for displaying the image will be referred to as the “first field” and the “second field”, respectively. That is, one frame period consists of the first field and the second field.

In the conventional liquid crystal display device employing the interlaced mode, as shown in FIGS. 4A to 4D, only the scanning signals G(1) and G(3) applied to the odd-numbered-row gate bus lines are activated within the first field, and only the scanning signals G(2) and G(4) applied to the even-numbered-row gate bus lines are activated within the second field. The driving video signal Sa and the driving video signal Sb are of opposite polarities, and both the signals Sa and Sb are switched between positive polarity and negative polarity every second horizontal scanning period (polarity inversion). The polarity inversion is performed when any scanning signal is activated in both the first and second fields.

With the above operation, for example, in pixel formation portions provided in association with intersections of the first-row gate bus line and the odd-numbered-column source bus lines, writing to pixel capacitances for positive polarity is performed during a period from time point t11 to time point t12. The data (charge) being written is retained until writing is performed again within the first field of the next frame period since writing to pixel capacitances in the aforementioned pixel formation portions is not performed within the second field. Similarly, in other pixel formation portions, when writing to the pixel capacitance is performed within either the first or second field, data (charge) is retained until writing is performed again in the next frame period.

As described above, in each pixel formation portion, writing to the pixel capacitance is performed only once within either the first or second field. Accordingly, in the case of the interlaced mode, the number of times of writing to pixel capacitances during a certain period is halved compared to the progressive mode. Also, in a horizontal scanning period, such as a period from time point t12 to time point t13 in FIG. 4, where no scanning signal is activated, the potentials of the driving video signals Sa and Sb remain the same as those for the immediately preceding horizontal scanning period. Thus, in the case of the interlaced mode, the quantity of data transmission is also halved compared to the progressive mode. In this manner, power consumption is reduced.

[Patent Document 1] Japanese Laid-Open Patent Publication No. 2005-196008

### DISCLOSURE OF THE INVENTION

### Problems to be Solved by the Invention

Incidentally, in the case of hold-type display devices, such as liquid crystal display devices, once data (charge) to be retained in the pixel capacitance is written, the data is retained until subsequent rewriting. As a result, an image in each frame is temporally close to an image in its immediately preceding frame. Thus, when moving images are being displayed, an afterimage of a moving object occurs in the human vision. For example, afterimage AI occurs as if image OI representing a moving object is leaving a trace, as shown in FIG. 5.

According to the conventional liquid crystal display device employing the interlaced mode, data written to the pixel capacitance is retained for one frame period consisting of the first field and the second field. Therefore, a cycle for the writing to the pixel capacitance is doubled compared to the progressive mode. As a result, when moving images are being displayed, apparent responsiveness is significantly reduced, causing a reduction in visual quality.

Therefore, an objective of the present invention is, in a liquid crystal display device employing the interlaced mode, to prevent reduction in visual quality when displaying moving images and to reduce power consumption while inhibiting the reduction in visual quality.

### Means for Solving the Problems

A first aspect of the present invention is directed to an active-matrix liquid crystal display device for displaying an image by plural rounds of vertical scanning, the device comprising:

a display portion including a plurality of video signal lines for one or more colors for respectively transmitting a plurality of driving video signals representing an image to be displayed, a plurality of scanning signal lines crossing the video signal lines, and a plurality of pixel formation portions arranged in a matrix in association with intersections of the video signal lines and the scanning signal lines;

a video signal line driving circuit for generating a plurality of internal video signals to be applied to the video signal lines as the driving video signals;

a scanning signal line driving circuit for selectively driving all the scanning signal lines by a single round of vertical scanning; and

a black signal insertion circuit provided inside or outside the video signal line driving circuit for setting the driving video signals at a voltage corresponding to a black display within a section of a period for the single round of vertical scanning being performed, wherein any one of the scanning signal lines is driven within the section, and the section excludes another section of the period in which the driving video signals based on the image are applied to the video signal lines.

In a second aspect of the present invention, based on the first aspect of the invention, a normally black mode is employed as a drive mode, and the black signal insertion circuit sets the driving video signals at the voltage corresponding to a black display by short-circuiting, of the video signal lines, any pair of video signal lines having driving video signals of different polarities applied thereto.

In a third aspect of the present invention, based on the second aspect of the invention, the video signal line driving circuit, for the video signal lines for each color, renders internal video signals different in polarity, the internal video signals being applied to any adjacent lines chosen from among the video signal lines, and the black signal insertion circuit, for the video signal lines for each color, sets the driving video signals at the voltage corresponding to a black display by short-circuiting any adjacent lines chosen from among the video signal lines.

In a fourth aspect of the present invention, based on the first aspect of the invention, the video signal line driving circuit subjects the internal video signals to polarity inversion every number of horizontal scanning periods equal to the number of rounds of vertical scanning required for displaying the image, the black signal insertion circuit sets the driving video signals at the voltage corresponding to a black display after a lapse of one horizontal scanning period since the polarity inversion of the internal video signals until the next polarity inversion of the internal video signals, and the scanning signal line driving circuit sequentially drives the scanning signal lines each being selected for one horizontal scanning period during the single round of vertical scanning.

In a fifth aspect of the present invention, based on the first aspect of the invention, the device is of a driver monolithic type, wherein at least one of the video signal line driving circuit and the scanning signal line driving circuit is formed on the same board as the display portion.

A sixth aspect of the present invention is directed to a driver circuit for an active-matrix liquid crystal display device for displaying an image by plural rounds of vertical scanning, the device having a display portion including a plurality of video signal lines for one or more colors for respectively transmitting a plurality of driving video signals representing an image to be displayed, a plurality of scanning signal lines crossing the video signal lines, and a plurality of pixel formation portions arranged in a matrix in association with intersections of the video signal lines and the scanning signal lines, the circuit comprising:

a video signal line driving circuit for generating a plurality of internal video signals to be applied to the video signal lines as the driving video signals;

a scanning signal line driving circuit for selectively driving all the scanning signal lines by a single round of vertical scanning; and

a black signal insertion circuit provided inside or outside the video signal line driving circuit for setting the driving video signals at a voltage corresponding to a black display within a section of a period for the single round of vertical scanning being performed, wherein any one of the scanning signal lines is driven within the section, and the section excludes another section of the period in which the driving video signals based on the image are applied to the video signal lines.

In a seventh aspect of the present invention, based on the sixth aspect of the invention, a normally black mode is employed as a drive mode, and the black signal insertion circuit sets the driving video signals at the voltage corresponding to a black display by short-circuiting, of the video signal lines, any pair of video signal lines having driving video signals of different polarities applied thereto.

In an eighth aspect of the present invention, based on the seventh aspect of the invention, the video signal line driving circuit, for the video signal lines for each color, renders internal video signals different in polarity, the internal video signals being applied to any adjacent lines chosen from among the video signal lines, and the black signal insertion circuit, for the video signal lines for each color, sets the driving video signals at the voltage corresponding to a black display by short-circuiting any adjacent lines chosen from among the video signal lines.

In a ninth aspect of the present invention, based on the sixth aspect of the invention, the video signal line driving circuit subjects the internal video signals to polarity inversion every number of horizontal scanning periods equal to the number of rounds of vertical scanning required for displaying the image, the black signal insertion circuit sets the driving video signals at the voltage corresponding to a black display after a lapse of one horizontal scanning period since the polarity inversion of the internal video signals until the next polarity inversion of the internal video signals, and the scanning signal line driving circuit sequentially drives the scanning signal lines each being selected for one horizontal scanning period during the single round of vertical scanning.

A tenth aspect of the present invention is directed to a drive method for an active-matrix liquid crystal display device for displaying an image by plural rounds of vertical scanning, the device having a display portion including a plurality of video signal lines for one or more colors for respectively transmitting a plurality of driving video signals representing an image to be displayed, a plurality of scanning signal lines crossing the video signal lines, and a plurality of pixel formation portions arranged in a matrix in association with intersections of the video signal lines and the scanning signal lines, the method comprising:

an internal video signal generation step for generating a plurality of internal video signals to be applied to the video signal lines as the driving video signals;

a scanning signal line driving step for selectively driving all the scanning signal lines by a single round of vertical scanning; and

a black signal insertion step for setting the driving video signals at a voltage corresponding to a black display within a section of a period for the single round of vertical scanning being performed, wherein any one of the scanning signal lines is driven within the section, and the section excludes another section of the period in which the driving video signals based on the image are applied to the video signal lines.

In an eleventh aspect of the present invention, based on the tenth aspect of the invention, a normally black mode is employed as a drive mode, and in the black signal insertion step, the driving video signals are set at the voltage corresponding to a black display by short-circuiting, of the video signal lines, any pair of video signal lines having driving video signals of different polarities applied thereto.

In a twelfth aspect of the present invention, based on the eleventh aspect of the invention, in the internal video signal line generation step, for the video signal lines for each color, internal video signals are rendered different in polarity, the internal video signals being applied to any adjacent lines chosen from among the video signal lines, and in the black signal insertion step, for the video signal lines for each color, the driving video signals are set at the voltage corresponding to a black display by short-circuiting any adjacent lines chosen from among the video signal lines.

In a thirteenth aspect of the present invention, based on the tenth aspect of the invention, in the internal video signal generation step, the internal video signals are subjected to polarity inversion every number of horizontal scanning periods equal to the number of rounds of vertical scanning required for displaying the image, in the black signal insertion step, the driving video signals are set at the voltage corresponding to a black display after a lapse of one horizontal scanning period since the polarity inversion of the internal video signals until the next polarity inversion of the internal video signals, and in the scanning signal line driving step, the scanning signal lines are sequentially driven, each line being selected for one horizontal scanning period during the single round of vertical scanning.

### EFFECT OF THE INVENTION

According to the first aspect of the present invention, in the liquid crystal display device employing the interlaced mode, a voltage corresponding to a black display is applied to video signal lines within a section of a period for a single round of vertical scanning being performed, excluding another section of the period in which driving video signals are applied to the video signal lines for displaying an image normally. As a result, the voltage corresponding to a black display is written to the pixel capacitance within a period during which writing to the pixel capacitance is conventionally not performed. Accordingly, for each pixel, inserting a black display is performed from the time when data writing is performed to the time when the next data writing is performed. Thus, in the liquid crystal display device employing the interlaced mode, pseudo-impulse drive is realized, preventing reduction in visual quality for displaying moving images.

According to the second aspect of the present invention, application of the voltage corresponding to a black display to video signal lines is performed by short-circuiting any pair of video signal lines having voltage of different polarities applied thereto. Accordingly, charge stored in the line capacitance of each video signal line is used to apply the voltage corresponding to a black display. Therefore, power consumption is not increased by inserting the black display. Thus, in the liquid crystal display device employing the interlaced mode, visual quality for displaying moving images can be prevented from being reduced while power consumption is reduced.

According to the third aspect of the present invention, application of the voltage corresponding to a black display to video signal lines is performed, for the video signal lines for each color, by short-circuiting any adjacent video signal lines. Accordingly, charge stored in the line capacitance of each video signal line is used to apply the voltage corresponding to a black display, so that as in the second aspect of the present invention, in the liquid crystal display device employing the interlaced mode, visual quality for displaying moving images can be prevented from being reduced while power consumption is reduced.

According to the fourth aspect of the present invention, operation, which is the same as in the progressive mode, is performed in the scanning signal line driving circuit. Thus, with a relatively simple configuration, it is possible to realize a liquid crystal display device employing the interlaced mode in which visual quality for displaying moving images can be prevented from being reduced.

According to the fifth aspect of the present invention, the display portion and the driving circuit are integrally formed on the same board, and therefore device size reduction can be achieved. Thus, in the case of mobile terminals, such as cell phones and PDAs, reduction in visual quality for displaying moving images can be prevented even if the interlaced mode is employed.

### BRIEF DESCRIPTION OF THE DRAWINGS

FIGS. 1A to 1I are signal waveform diagrams within one frame period for a liquid crystal display device according to an embodiment of the present invention.

FIG. 2 is a block diagram illustrating the overall configuration of the liquid crystal display device according to the embodiment.

FIG. 3 is a circuit diagram illustrating an exemplary configuration of an output portion of a source driver in the embodiment.

FIGS. 4A to 4F are signal waveform diagrams for a conventional liquid crystal display device employing the interlaced mode.

FIG. 5 is a diagram for explaining an afterimage in displaying moving images.

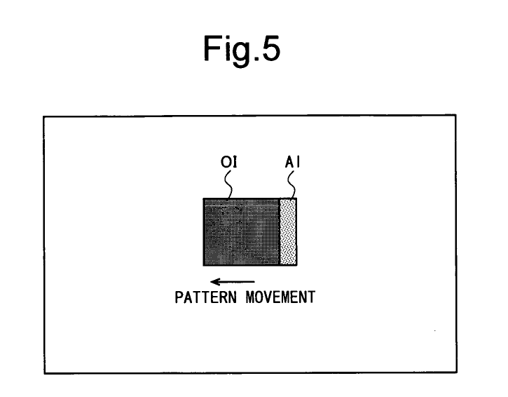

### DESCRIPTION OF THE REFERENCE CHARACTERS

10 TFT (switching element)
31 buffer (voltage follower)
100 display portion
200 display control circuit
300 source driver (video signal line driving circuit)
400 gate driver (scanning signal line driving circuit)
da analog voltage signal to be applied to odd-numbered-column source bus lines
db analog voltage signal to be applied to even-numbered-column source bus lines
Csh short-circuit control signal
G(j) scanning signal (j=1, 2, . . . , m)
Sa driving video signal to be applied to odd-numbered-column source bus lines
Sb driving video signal to be applied to even-numbered-column source bus lines

### BEST MODE FOR CARRYING OUT THE INVENTION

Hereinafter, an embodiment of the present invention will be described with reference to the accompanying drawings.

<1. Overall Configuration and Operation>

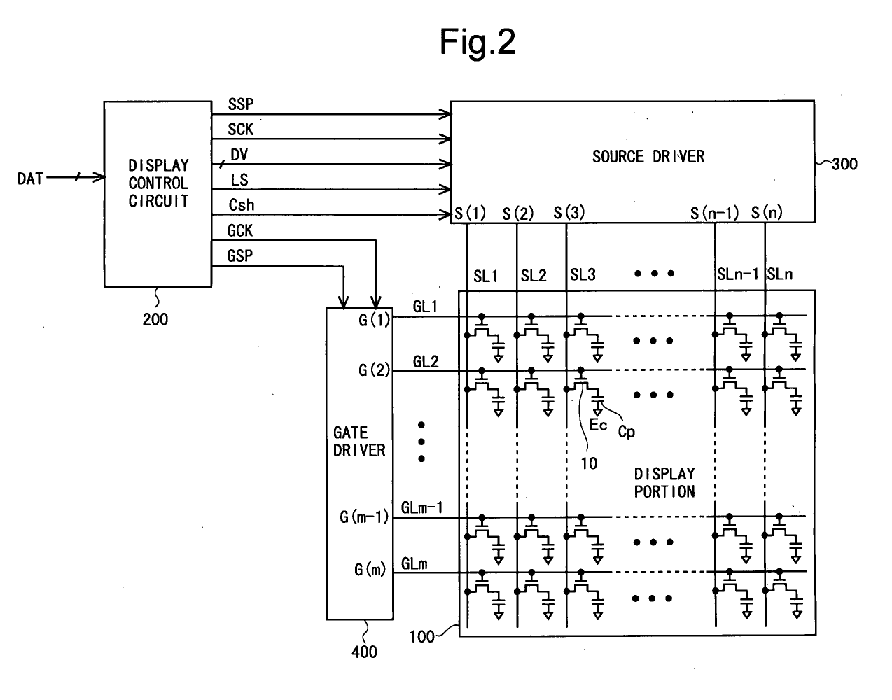

FIG. 2 is a block diagram illustrating the overall configuration of a liquid crystal display device according to an embodiment of the present invention. This liquid crystal display device includes a display portion 100, a display control circuit 200, a source driver (video signal line driving circuit) 300, and a gate driver (scanning signal line driving circuit) 400. Also, the liquid crystal display device is a “normally black type” display device in which a black display is provided when no voltage is being applied to a liquid crystal layer.

The display portion 100 includes a plurality (n) of source bus lines (video signal lines) SL1 to SLn, a plurality (m) of gate bus lines (scanning signal lines) GL1 to GLm, and a plurality (n×m) of pixel formation portions provided in association with intersections of the source bus lines SL1 to SLn and the gate bus lines GL1 to GLm. The pixel formation portions are arranged in a matrix to configure a pixel array. Each pixel formation portion consists of: a TFT 10, which is a switching element having a gate terminal connected to the gate bus line GLj passing its corresponding intersection and a source terminal connected to the source bus line SLi passing the intersection; a pixel electrode connected to a drain terminal of the TFT 10; a common electrode Ec, which is a counter electrode commonly provided for the pixel formation portions; and a liquid crystal layer commonly provided for the pixel formation portions and interposed between the pixel electrode and the common electrode Ec. Furthermore, a pixel capacitance Cp is configured by a liquid crystal capacitance formed by the pixel electrode and the common electrode Ec.

The display control circuit 200 receives externally transmitted image data DAT, and outputs a digital video signal DV, as well as a source start pulse signal SSP, a source clock signal SCK, a latch strobe signal LS, a short-circuit control signal Csh, a gate start pulse signal GSP, and a gate clock signal GCK, which are provided for controlling image display on the display portion 100. The source driver 300 receives the digital video signal DV, the source start pulse signal SSP, the source clock signal SCK, the latch strobe signal LS, and the short-circuit control signal Csh which are outputted from the display control circuit 200, and applies driving video signals S(1) to S(n) to the source bus lines SL1 to SLn. The gate driver 400 repeats application of active scanning signals G(1) to G(m) to the gate bus lines GL1 to GLm every vertical scanning period based on the gate start pulse signal GSP and the gate clock signal GCK outputted from the display control circuit 200. Note that this liquid crystal display device employs the interlaced mode, so that an image is displayed by two rounds of vertical scanning. In other words, a period required for displaying an image is equivalent to two vertical scanning periods.

Also, in this liquid crystal display device, adjacent source bus lines are short-circuited during odd- or even-numbered horizontal scanning periods within each field of frame periods. Such a mode in which adjacent source bus lines are short-circuited to equally share charge between the adjacent source bus lines is referred to as a “charge-sharing mode”.

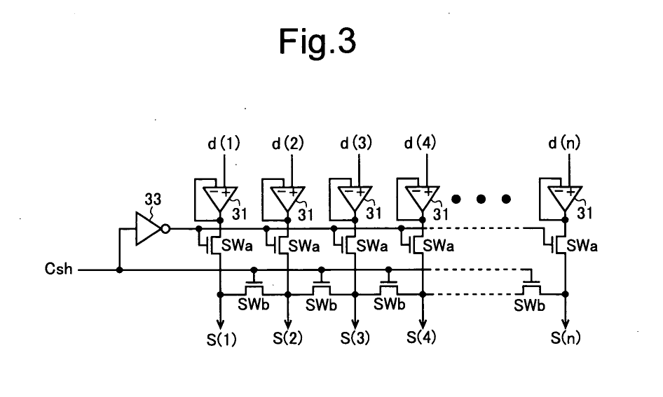

FIG. 3 is a circuit diagram illustrating the configuration of an output portion of the source driver 300 for realizing the charge-sharing mode. The output portion receives analog voltage signals d(1) to d(n), as internal video signals, generated based on the digital video signal DV, and performs impedance conversion on the analog voltage signals d(1) to d(n), thereby generating driving video signals S(1) to S(n) to be transmitted via the source bus lines SL1 to SLn, and the output portion includes n buffers 31 as voltage followers for the impedance conversion. To an output terminal of each buffer 31 a first MOS transistor SWa serving as a switching element is connected, and the driving video signal S(i) from the buffer 31 is outputted from the output terminal of the source driver 300 via the first MOS transistor SWa (i=1, 2, . . . , n). Also, adjacent output terminals in the source driver 300 are connected by a second MOS transistor SWb serving as a switching element. In addition, the short-circuit control signal Csh is given to the gate terminal of the second MOS transistor SWb between the output terminals, whereas an output signal of an inverter 33, i.e., a logical inversion signal of the short-circuit control signal Csh, is given to a gate terminal of the first MOS transistor SWa connected to the output terminal of the buffer 31. Accordingly, when the short-circuit control signal Csh is inactive (low level), the first MOS transistor SWa is turned ON, and the second MOS transistor SWb is turned OFF, so that the driving video signal from the buffer 31 is outputted from the source driver 300 via the first MOS transistor SWa. On the other hand, when the short-circuit control signal Csh is active (high level), the first MOS transistor SWa is turned OFF, and the second MOS transistor SWb is turned ON, so that the driving video signal from the buffer 31 is not outputted, and adjacent source bus lines in the display portion 100 are short-circuited via the second MOS transistor SWb. In the present embodiment, a black signal insertion circuit is realized by the configuration as described above. Note that proposals have already been made to short-circuit adjacent source bus lines at the time of polarity inversion of driving video signal, thereby causing the voltage of each source bus line to approximate a blacking voltage for the purpose of reducing power consumption, and the configuration for short-circuiting adjacent source bus lines is not limited to that shown in FIG. 3.

With the configuration as described above, driving video signals are applied to the source bus lines SL1 to SLn, and scanning signals are applied to the gate bus lines GL1 to GLm, so that an image is displayed on the display portion 100.

<2. Drive Method>

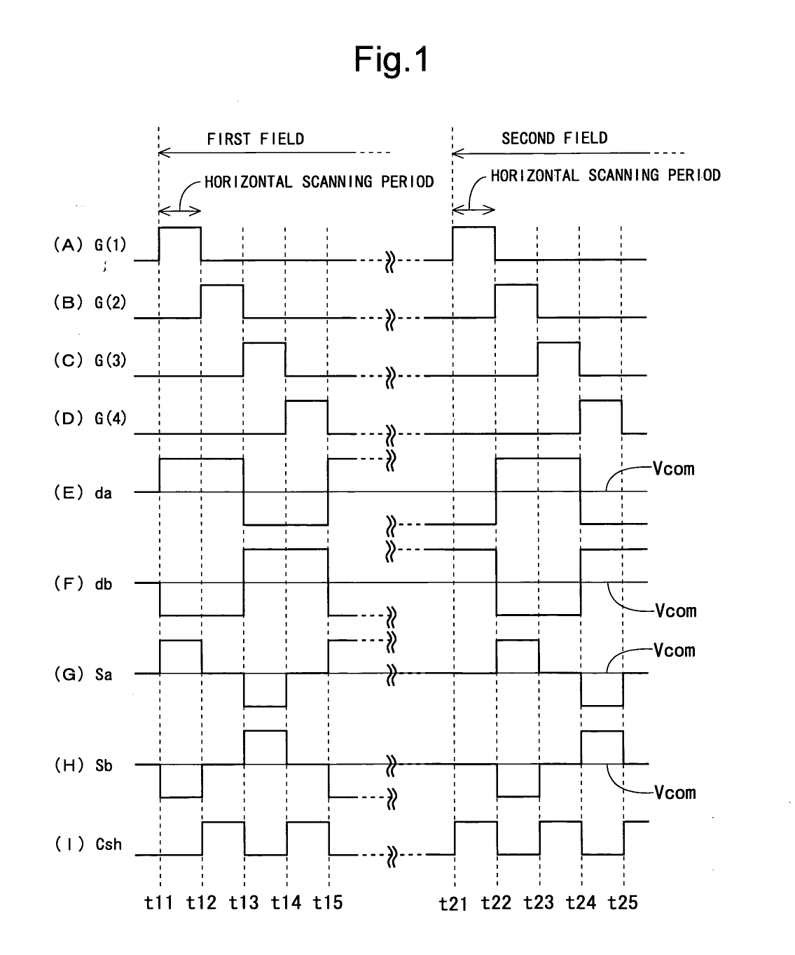

FIG. 1 provides signal waveform diagrams within one frame period in the present embodiment. Note that one frame period refers to a period required for displaying an image to be displayed on the display portion 100, and the first and second vertical scanning periods for displaying an image are referred to as the “first field” and the “second field”, respectively. Also, in FIG. 1, the first field starts at time point t11, and the second field starts at time point t21. In addition, as for the analog voltage signals d(1) to d(n) generated based on the digital video signal DV, signals to be applied to odd-numbered-column source bus lines are denoted by reference character da, and signals to be applied to even-numbered-column source bus lines are denoted by reference character db. Furthermore, driving video signals to be applied to odd-numbered-column source bus lines are denoted by reference character Sa, and driving video signals to be applied to even-numbered-column source bus lines are denoted by reference character Sb.

As shown in FIGS. 1A to 1D, the scanning signals G(1) to G(4) respectively applied to the first- to fourth-row gate bus lines GL1 to GL4 are sequentially activated every horizontal scanning period within the first and second fields. In this manner, the scanning signals G(1) to G(m) applied to the first- to m'th-row gate bus lines GL1 to GLm are sequentially activated every horizontal scanning period during the vertical scanning periods of both the first and second fields. Thus, as for each pixel electrode of the pixel formation portions provided in association with the intersections of the gate bus lines to which the active scanning signal is being applied and the source bus lines SL1 to SLn, the voltage of the driving video signal (the difference between the potential Vcom of the common electrode and the potential Sa, Sb, of the driving video signal) being applied to its corresponding source bus line is applied to the pixel electrode during the period in which the scanning signal is active.

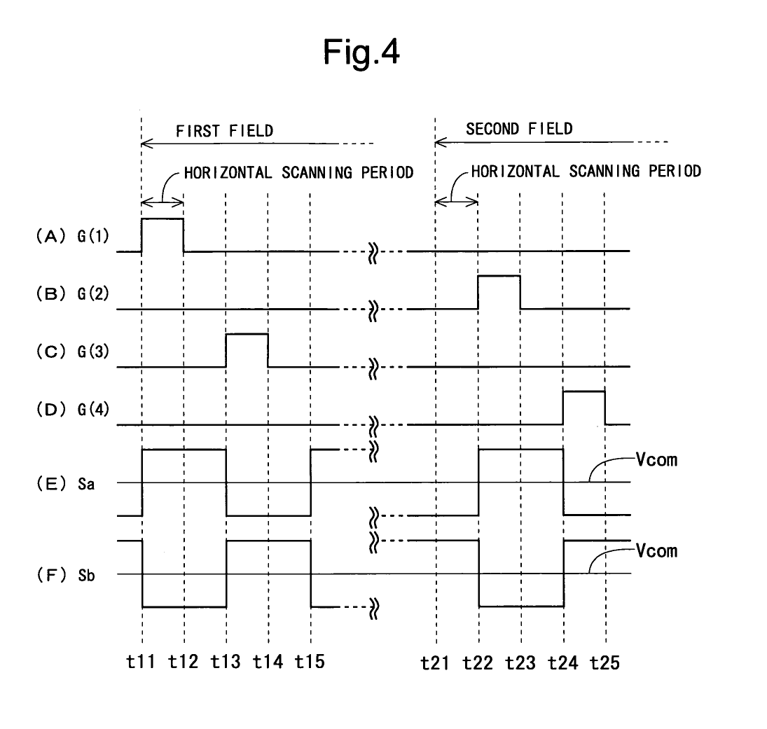

The analog voltage signals da and db have the same waveforms as those of the driving video signals Sa and Sb, respectively, in the conventional art as exemplified in FIGS. 4E and 4F. Specifically, within the first field, the analog voltage signal da (conforming to the potential Vcom of the common electrode) is positive during two horizontal scanning periods from time point t11 to time point t13, and negative during two horizontal scanning periods from time point t13 to time point t15, as shown in FIG. 1E. After time point t15, the polarity statuses from time point t11 to time point t15 are repeated. Also, within the second field, the signal is negative during one horizontal scanning period from time point t21 to time point t22, positive during two horizontal scanning periods from time point t22 to time point t24, and negative during one horizontal scanning period from time point t24 to time point t25. After time point t25, the polarity statuses from time point t21 to time point t25 are repeated. On the other hand, the analog voltage signal db has an opposite polarity to the analog voltage signal da during vertical scanning periods of both the first and second fields, as shown in FIG. 1F.

Here, in the present embodiment, the short-circuit control signal Csh having a waveform as shown in FIG. 1I is given to the output portion of the source driver 300 from the display control circuit 200. Specifically, the short-circuit control signal Csh, which is at high level during periods (from time point t12 to time point t13, and from time point t14 to time point t15 in FIG. 1) in which scanning signals applied to the even-numbered-row gate bus lines are activated within the first field and is at high level during periods (from time point t21 to time point t22, and from time point t23 to time point t24 in FIG. 1) in which scanning signals applied to the odd-numbered-row gate bus lines are activated within the second field, is given to the output portion of the source driver 300. Thus, within the first field, adjacent source bus lines are short-circuited during periods in which scanning signals applied to even-numbered-row gate bus lines are active. In addition, within the second field, adjacent source bus lines are short-circuited during periods in which scanning signals applied to odd-numbered-row gate bus lines are active.

In this manner, adjacent source bus lines are short-circuited, and the adjacent source bus lines are opposite in voltage polarity but approximately equal in absolute value of the voltage. Accordingly, during the periods of short circuit, the driving video signals Sa and Sb both approximately correspond to a blacking voltage. As a result, the driving video signals Sa and Sb have waveforms as shown in FIGS. 1(G) and 1(H), respectively.

<3. Effects>

As described above, according to the present embodiment, in the liquid crystal display device employing the interlaced mode, a voltage corresponding to a black display is applied to the source bus lines during a period after a lapse of one horizontal scanning period since polarity inversion of the analog voltage signals da and db until the next polarity inversion of the analog voltage signals da and db. Also, during this period, even-numbered-row gate bus lines are selectively driven within the first field, and odd-numbered-row gate bus lines are selectively driven within the second field. Therefore, in each pixel formation portion, a voltage corresponding to a black display is written to the pixel capacitance within a field different from that within which writing to that pixel capacitance was performed. Thus, in the liquid crystal display device employing the interlaced mode, pseudo-impulse driving is realized, preventing reduction in visual quality in displaying moving images.

Also, application of a voltage corresponding to a black display to source bus lines is performed by short-circuiting adjacent source bus lines. Accordingly, charge stored in the line capacitance of each source bus line is used to apply the voltage corresponding to a black display. Therefore, power consumption is not increased by the writing of the voltage corresponding to a black display to the pixel capacitance. Thus, in the liquid crystal display device employing the interlaced mode, visual quality for displaying moving images can be prevented from being reduced while power consumption is reduced.

Furthermore, in the above embodiment, the gate driver 400 sequentially drives the gate bus lines one by one in a similar manner to progressive mode display devices. Thus, with a relatively simple configuration, it is possible to realize a liquid crystal display device employing the interlaced mode in which visual quality for displaying moving images can be prevented from being reduced.

<4. Others>

In the above embodiment, a system-on-glass configuration can be achieved in which at least one of the source driver 300 and the gate driver 400 is monolithically formed on the same board as the display portion 100. Thus, in compact display devices for cell phones, PDAs, etc., visual quality for displaying moving images can be prevented from being reduced while power consumption is reduced.

Also, in the above embodiment, for inserting a black display, adjacent source bus lines are short-circuited by providing the source driver 300 employing the charge-sharing mode, but the present invention is not limited to this. For example, a feature (black signal insertion circuit) for short-circuiting adjacent source bus lines may be provided outside the source driver 300, or it may be configured that each source bus line and the common electrode are short-circuited.

Furthermore, in the above embodiment, it is configured that adjacent source bus lines are short-circuited, but the present invention is not limited to this. For example, in the case of a color liquid crystal display device including source bus lines for each of the colors R, G, and B, short circuit is caused between source bus lines for the same color to which voltage is applied with mutually opposite polarities (when looking at a given source bus line, between that source bus line and another source bus line disposed in the third column therefrom).

1. An active-matrix liquid crystal display device for displaying an image by plural rounds of vertical scanning, the device comprising:
a display portion including a plurality of video signal lines for one or more colors for respectively transmitting a plurality of driving video signals representing an image to be displayed, a plurality of scanning signal lines crossing the video signal lines, and a plurality of pixel formation portions arranged in a matrix in association with intersections of the video signal lines and the scanning signal lines;
a video signal line driving circuit for generating a plurality of internal video signals to be applied to the video signal lines as the driving video signals;
a scanning signal line driving circuit for selectively driving all the scanning signal lines by a single round of vertical scanning; and
a black signal insertion circuit provided inside or outside the video signal line driving circuit for setting the driving video signals at a voltage corresponding to a black display within a section of a period for the single round of vertical scanning being performed, wherein any one of the scanning signal lines is driven within the section, and the section excludes another section of the period in which the driving video signals based on the image are applied to the video signal lines.

2. The liquid crystal display device according to claim 1, wherein,
a normally black mode is employed as a drive mode, and
the black signal insertion circuit sets the driving video signals at the voltage corresponding to a black display by short-circuiting, of the video signal lines, any pair of video signal lines having driving video signals of different polarities applied thereto.

3. The liquid crystal display device according to claim 2, wherein,
the video signal line driving circuit, for the video signal lines for each color, renders internal video signals different in polarity, the internal video signals being applied to any adjacent lines chosen from among the video signal lines, and
the black signal insertion circuit, for the video signal lines for each color, sets the driving video signals at the voltage corresponding to a black display by short-circuiting any adjacent lines chosen from among the video signal lines.

4. The liquid crystal display device according to claim 1, wherein,
the video signal line driving circuit subjects the internal video signals to polarity inversion every number of horizontal scanning periods equal to the number of rounds of vertical scanning required for displaying the image,
the black signal insertion circuit sets the driving video signals at the voltage corresponding to a black display after a lapse of one horizontal scanning period since the polarity inversion of the internal video signals until the next polarity inversion of the internal video signals, and
the scanning signal line driving circuit sequentially drives the scanning signal lines each being selected for one horizontal scanning period during the single round of vertical scanning.

5. The liquid crystal display device according to claim 1, being of a driver monolithic type, wherein at least one of the video signal line driving circuit and the scanning signal line driving circuit is formed on the same board as the display portion.

6. A driving circuit for an active-matrix liquid crystal display device for displaying an image by plural rounds of vertical scanning, the device having a display portion including a plurality of video signal lines for one or more colors for respectively transmitting a plurality of driving video signals representing an image to be displayed, a plurality of scanning signal lines crossing the video signal lines, and a plurality of pixel formation portions arranged in a matrix in association with intersections of the video signal lines and the scanning signal lines, the circuit comprising:
a video signal line driving circuit for generating a plurality of internal video signals to be applied to the video signal lines as the driving video signals;
a scanning signal line driving circuit for selectively driving all the scanning signal lines by a single round of vertical scanning; and
a black signal insertion circuit provided inside or outside the video signal line driving circuit for setting the driving video signals at a voltage corresponding to a black display within a section of a period for the single round of vertical scanning being performed, wherein any one of the scanning signal lines is driven within the section, and the section excludes another section of the period in which the driving video signals based on the image are applied to the video signal lines.

7. The driving circuit according to claim 6, wherein,
a normally black mode is employed as a drive mode, and
the black signal insertion circuit sets the driving video signals at the voltage corresponding to a black display by short-circuiting, of the video signal lines, any pair of video signal lines having driving video signals of different polarities applied thereto.

8. The driving circuit according to claim 7, wherein,
the video signal line driving circuit, for the video signal lines for each color, renders internal video signals different in polarity, the internal video signals being applied to any adjacent lines chosen from among the video signal lines, and
the black signal insertion circuit, for the video signal lines for each color, sets the driving video signals at the voltage corresponding to a black display by short-circuiting any adjacent lines chosen from among the video signal lines.

9. The driving circuit according to claim 6, wherein,
the video signal line driving circuit subjects the internal video signals to polarity inversion every number of horizontal scanning periods equal to the number of rounds of vertical scanning required for displaying the image,
the black signal insertion circuit sets the driving video signals at the voltage corresponding to a black display after a lapse of one horizontal scanning period since the polarity inversion of the internal video signals until the next polarity inversion of the internal video signals, and
the scanning signal line driving circuit sequentially drives the scanning signal lines each being selected for one horizontal scanning period during the single round of vertical scanning.

10. A driving method for an active-matrix liquid crystal display device for displaying an image by plural rounds of vertical scanning, the device having a display portion including a plurality of video signal lines for one or more colors for respectively transmitting a plurality of driving video signals representing an image to be displayed, a plurality of scanning signal lines crossing the video signal lines, and a plurality of pixel formation portions arranged in a matrix in association with intersections of the video signal lines and the scanning signal lines, the method comprising:
an internal video signal generation step for generating a plurality of internal video signals to be applied to the video signal lines as the driving video signals;
a scanning signal line driving step for selectively driving all the scanning signal lines by a single round of vertical scanning; and
a black signal insertion step for setting the driving video signals at a voltage corresponding to a black display within a section of a period for the single round of vertical scanning being performed, wherein any one of the scanning signal lines is driven within the section, and the section excludes another section of the period in which the driving video signals based on the image are applied to the video signal lines.

11. The driving method according to claim 10, wherein,
a normally black mode is employed as a drive mode, and
in the black signal insertion step, the driving video signals are set at the voltage corresponding to a black display by short-circuiting, of the video signal lines, any pair of video signal lines having driving video signals of different polarities applied thereto.

12. The driving method according to claim 11, wherein,
in the internal video signal line generation step, for the video signal lines for each color, internal video signals are rendered different in polarity, the internal video signals being applied to any adjacent lines chosen from among the video signal lines, and
in the black signal insertion step, for the video signal lines for each color, the driving video signals are set at the voltage corresponding to a black display by short-circuiting any adjacent lines chosen from among the video signal lines.

13. The driving method according to claim 10, wherein,
in the internal video signal generation step, the internal video signals are subjected to polarity inversion every number of horizontal scanning periods equal to the number of rounds of vertical scanning required for displaying the image,
in the black signal insertion step, the driving video signals are set at the voltage corresponding to a black display after a lapse of one horizontal scanning period since the polarity inversion of the internal video signals until the next polarity inversion of the internal video signals, and
in the scanning signal line driving step, the scanning signal lines are sequentially driven, each line being selected for one horizontal scanning period during the single round of vertical scanning.
